(19) United States
(12) Patent Application Publication
(10) Pub. No.: US 2017/0126520 A1
(43) Pub. Date: May 4, 2017

(54) TEST SESSION SIMILARITY DETERMINATION

(71) Applicant: Hewlett Packard Enterprise Development LP, Houston, TX (US)

(72) Inventors: Efrat Egozi Levi, Yehud (IL); Rotem Elisadeh, Yehud (IL); Ohad Assulin, Yehud (IL)

(21) Appl. No.: 14/932,640

(22) Filed: Nov. 4, 2015

(51) Int. Cl. H04L 12/26; H04L 29/08

(52) U.S. Cl. CPC H04L 43/045; H04L 67/306; H04L 67/14; H04L 43/08

(57) ABSTRACT

In one example in accordance with the present disclosure, a method for test session similarity determination includes capturing a sequence of events from a user session of an application and converting the captured sequence into a data format used for a test sequence. The method also includes converting each event in the test sequence that is not in the captured sequence into a disparate event and creating a unique set including each unique event in the captured sequence and the disparate event. The method also includes determining a first average relative location of the event in the captured sequence and a second average relative location of each event in the rest sequence. The method also includes determining a degree of similarity between the captured sequence and the test sequence based on a comparison of the first and second average relative location and automatically generating a visualization highlighting the degree of similarity.

### BACKGROUND

Services and applications may be monitored in various degrees of detail. This information may be used to improve the user experience and to enable an application owner to create an application that is the best fit for users.

### BRIEF DESCRIPTION OF THE DRAWINGS

The following detailed description references the drawings, wherein:

FIG. 1 is a block diagram of an example system for test session similarity determination;

FIG. 2 is a flowchart of an example method for test session similarity determination;

FIG. 3 is a flowchart of an example method for test session similarity determination;

FIG. 4 is a block diagram of an example system for test session similarity determination; and

FIG. 5 is a block diagram of an example system for test session similarity determination.

### DETAILED DESCRIPTION

Monitoring tools may capture a user session of an application. The application may be a web application, native application, a service. Etc. A user session is the actual sequence of events performed by a user while using the application/service. The user session, or a portion thereof, may be compared to a test session to determine if testing is accurately covering actual usage patterns. Accordingly, a test session is a sequence of events performed during testing of the application. Testing may be performed by a party responsible for the application, such as the owner, developer, quality assurance team, etc. In other words, the test session may be a sequence of events that the tester believes that the user may perform and thus may perform this sequence of events to ensure that the application/service works properly.

Example methods for test session similarity determination may capture user sessions and compare the user sessions to test sessions. The sessions may be analyzed to determine a similarity measure between the two. The similarity measure may consider the similarity of the actual events in the user session and the test session as well as the order of the events in the two sessions. In this manner, the similarity measure may be used to discover gaps between what events are being tested for and what events are actually being performed by users of the application. Once any differences have been determined, the testing can be adjusted to cover the actual uses.

Some traditional methods for comparing sessions do not accurately consider repetition of events when determining similarity. However, actions may be repeated during actual user sessions. For example, if a certain functionality of an application is not working properly, a user may continue to perform an action to execute the functionality. Accordingly, it is important to account for these repetitions when determining the similarity between sessions. Moreover, some traditional methods may not accurately determine similarity between sessions with different numbers of event.

An example method for test session similarity determination may include capturing a sequence of events from a user session of an application and converting the captured sequence into a data format used for a test sequence. The method may also include converting each event in the test sequence that is not in the captured sequence into a disparate event and creating a unique set including each unique event in the captured sequence and the disparate event. The method may also include determining, for each event in the unique set, a first average relative location of the event in the captured sequence and a second average relative location of the event in the test sequence. The method may also include determining a degree of similarity between the captured sequence and the test sequence based on a comparison of the first and second average location and automatically generating a visualization highlighting the degree of similarity between the captured session and the test session.

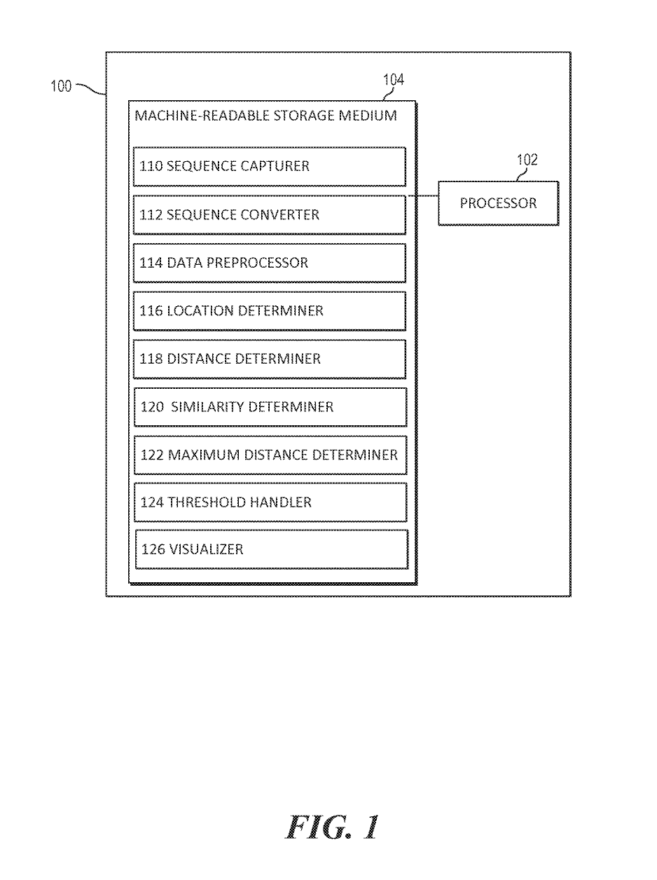

FIG. 1 is a block diagram of an example system 100 for test session similarity determination. System 100 may include a processor 102 and a memory 104 that may be coupled to each other through communication link (e.g., a bus). Processor 102 may include a Central Processing Unit (CPU) or another suitable processor. In some examples, memory 104 stores machine readable instructions executed by processor 102 for operating system 100. Memory 104 may include any suitable combination of volatile and/or non-volatile memory, such as combinations of Random Access Memory (RAM), Read-Only Memory (ROM), flash memory, and/or other suitable memory.

Memory 104 stores instructions to be executed by processor 102 including instructions for a sequence capturer 110, a sequence converter 112, data preprocessor 114, a location determiner 116, a distance determiner 118, a similarity determiner 120, a maximum distance determiner 122, a threshold handler 124, a visualizer 126, and/or other components. According to various implementations, test session similarity determination system 100 may be implemented in hardware and/or a combination of hardware and programming that configures hardware. Furthermore, in FIG. 1 and other Figures described herein, different numbers of components or entities than depicted may be used.

Processor 102 may execute instructions of sequence capturer 110 to capture a sequence of events. The sequence of events may be captured by a monitoring tool. The monitoring tool may express each captured event using a standardized set of event names. Sequence capturer 110 may capture the sequence of events from a user session of an application, a test session, etc. A sequence of events is a series of events performed by the application within a given time frame.

The sequence may include events performed by the service or application, such as actions, web pages visited, etc. An example sequence hereinafter sequence 1) may look something like what is shown in Table 1 below.

TABLE 1

1. Login
2. Open Chat
3. Attach
4. Write Message
5. Write Message
6. Write Message
7. Attach
8. Write Message
9. Send

Although the example sequence in Table 1 is shown in numbered order, the sequence could be provided in other forms, such as coma separated events.

Processor 102 may execute instructions of sequence converter 112 to convert the captured sequence into a data format used for a test sequence. For example, each unique event in the captured sequence may be converted to a unique numeric representation. For example, in the example sequence of Table 1, the “login” event may be converted to “1,” the “open chat” event may be converted to “2,” the “attach” event may be converted to “3,” the “write message” event may be converted to “4” and the “send event” may be converted to “5.” Using this conversion, the example sequence may be described as “1, 2, 3, 4, 4, 4, 3, 4, 5.”

The user session is captured so that it can be compared to a second session. The second session may be a test session, a previously captured user session, etc. Before a similarity between the captured session and a second session is determined and visualized, the captured session and/or the second session may be preprocessed. Processor 102 may execute instructions of data preprocessor 114 to select one sequence as the base sequence for comparison to the other sequence (hereinafter the “comparison sequence”). Processor 102 may execute instructions of data preprocessor 114 to select either session may be chosen as the base sequence. However, as will be discussed in further detail below, a similarity measure may be determined. Accordingly, processor 102 may execute instructions of data preprocessor 114 to preprocess the user session with respect to the second session and preprocess the second session with respect to the user session

Processor 102 may execute instructions of data preprocessor 114 to convert each event in the base sequence that is not in the comparison sequence into a disparate event. The disparate event is an event that does not appear in any sequence and may be represented by any character that is not present in any of the sequences. For example, the disparate event may be represented by a symbol, such as “#.”.

Processor 102 may execute instructions of data preprocessor 114 to identify consecutive disparate events in the comparison sequence and combine the consecutive disparate events into a single disparate event. Processor 102 may also execute instructions of data preprocessor 114 to create a unique set including each unique event in the captured sequence and the disparate event.

Processor 102 may execute instructions of sequence converter 112 to represent a base sequence as a vector of “1, 5” and convert the comparison sequence into a vector is “1, 2, 5, 3, 4.” Processor 102 may execute instructions of data preprocessor 114 to convert each event that is not in the base sequence (“2,” “3” and “4”) into disparate events, represented by the “#” symbol. The comparison sequence may now be represented as “1, #, #, 5, #”. Processor 102 may also execute instructions of data preprocessor 114 to combine the consecutive disparate events in the comparison sequence. The comparison sequence may thus be represented as “1, #, 5,#.”Accordingly, the unique set of events in the base sequence and the comparison sequence may be unique set {1, 5, #} including the events “1,” “5” and “#.”

Processor 102 may execute instructions of location determiner 116 to determine, for each event in the unique set, a first average relative location of the event in the base sequence and a second average relative location of the event in the comparison sequence. In other words, location determiner 116 may determine an average relative location for each event in the sequence. The relative location may be the event's order in the sequence divided by the length of the sequence, e.g. the relative location of event “3” in a sequence “1, 2, 3” is 3/3. The average relative location may be the average of the event's locations in a sequence. For example, if event eᵢ appears in locations j and k in sequence seq2 then sₖ=sⱼ=e_{i.} And for event a the average relative location in seq2 would be the average of (j/in, k/in). If an event does not exist in the sequence then the value may be set to zero.

For example, if the unique set of events is {1, #, 5}, the event vector L1 for the processed comparison sequence (“1, #, 5, #”) would be [¼, avg( 2/4,4/4), ¾], thus L1=[0.25, 0.75, 0.75]. Similarly the event vector L2 for the base sequence (“1, 5”) (would be [½, 2/2. 0/2], thus L2=[0.5, 1, 0].

Processor 102 may execute instructions of distance determiner 118 to determine, for each event in the unique set, a first distance between the first average relative location and the second average relative location. In other words, processor 102 may execute instructions of distance determiner 118 to calculate a location distance for each event which is the distance between its average relative locations in the sequence. Processor 102 may execute instructions of distance determiner distance determiner 118 to further determine, for each event in the unique set, a distance defining the difference of the first distance from a maximum distance. Since the locations of the events are relative, the maximum average relative location possible is 1 and the minimum average relative location possible is 0.

Processor 102 may execute instructions of similarity determiner 120 to determine a degree of similarity between the base sequence and the comparison sequence. The degree of similarity may be based on a comparison of the first and second average relative locations, the distance between the first relative average location and the second relative average location, the difference of the first distance from a maximum distance or any combination of these values.

The degree of similarity for between the base sequence and the comparison sequence may be expressed by a similarity score. Processor 102 may execute instructions of similarity determiner 120 to find the average of the location distances from the maximum for each event in the sequence. For example, if the sequences are identical then the average relative locations for each event per sequence is the same. The distance between the average relative locations may be zero and the distance from the maximum will be 1. Identical sequences may have a maximum similarity score of 1 for each event and the overall similarity score of sequence will be 1.

The techniques discussed herein are not limited to just comparing a user session to a test session. In some examples, processor 102 may execute instructions of similarity determiner 120 to use the techniques described herein to determine a degree of similarity between any two sessions. For example, user sessions may be compared to other user sessions, test session may be compared to other test sessions, test sessions may be compared to a user sessions, or any combination of sessions,

In some examples, similarity determiner 120 may incorporate an example formula to determine the similarity score S using the average relative locations (e.g., as discussed herein with respect to location determiner 116) of the events in the base sequence (seq1) and the comparison sequence (seq2) may be described as: S(seq1, seq2)=sum(abs(1-abs(L1−L2)))/length(L1). For example, using the example described above, the unique set of events may include {1, 5, #}, the event vector L1 for the processed comparison sequence may be [0.25, 0.75, 0.75] and the event vector L2 for the base sequence may be [0.5, 1, 0]. Using the above formula, the similarity score S may be calculated as: S (seq1, seq2)=(sum(abs(1-abs([0.25, 0.75, 0.75]−[0.5, 1, 0])))/3 or s=0.58.

As described above, the similarity score is asymmetric in nature, as it uses one sequence as the base for comparison. Accordingly, the similarity between a preprocessed first session with respect to the second session represents how similar the first session is to the second session. A similarity between a preprocessed second session with respect to the first session represents how similar the second session is to the first session. These two similarities, however, are not necessarily identical. Using the above example formula, the similarity between a preprocessed first session with respect to the second session is 0.58, while similarity between a preprocessed second session with respect to the first session is 0.72.

Processor 102 may execute instructions of a maximum distance determiner 122 to make the degree of similarity symmetric. Maximum distance determiner 122 may incorporate a technique for determining the maximum between the two similarity scores.

Processor 102 may execute instructions of a visualizer 124 may generate a visualization of the degree of similarity. The visualization may be represented as a graph, a chart, etc. For example, the visualizer 134 may automatically generate a visualization that displays the degree of similarity between the base sequence and the comparison sequence. In this manner, the visualizer 130 may provide the user an easy to understand visualization of the discovered gaps between the base sequence and the comparison sequence. The visualization may be presented to a user (such as an application developer, owner, quality assurance agent, etc.) and may be automatically recalibrated based on adjustments made threshold (as described below). In some examples a variety of user sessions may be analyzed based on the similarities between them. Processor 102 may execute instructions of a visualizer 124 to visually present these similarities to the user. Sessions that are considered similar may be clustered together in the visual presentation. In this manner, a variety of sessions can be presented with similar sessions grouped together.

Processor 102 may execute instructions of a threshold handler 126 to determine if the two sequences are considered a match. The threshold may be adaptive and may be modified either manually or automatically. The threshold may be represented by a binary value, such as yes or no, a ratio, such as a percentage, a word, a number, etc. In some examples, a default threshold may be used, such as 0.75. In some aspects, a threshold of at least 0.5 may be recommended. Of course this is only an example default threshold and any value between 0 and 1 may be used as the threshold. The visualization may be recalibrated based on adjustments made to the threshold.

Processor 102 may execute instructions of a threshold handler 126 to compare the degree of similarity to the threshold. The threshold may be based on the first and second average relative location, the similarity score, degree of similarity, etc. In this manner, the threshold handler may be used to determine if the two sequences are considered a match. The threshold may be adaptive and may be modified either manually or automatically. The threshold may be represented by a binary value, such as yes or no, a ratio, such as a percentage, a word, a number, etc. In some examples, a default threshold may be used, such as 0.75. In some aspects, a threshold of at least 0.5 may be recommended. Of course this is only an example default threshold and any value between 0 and 1 may be used as the threshold.

A threshold adjuster 130 may adjust a sensitivity of the adaptive threshold based on a length of at least one of the first sequence or the second sequence. For example, the example default threshold of 0.75 may be too strict for short sequences. Accordingly, in some aspects, different thresholds may be automatically applied to sequences of different lengths. The visualization may be recalibrated based on adjustments made to the threshold.

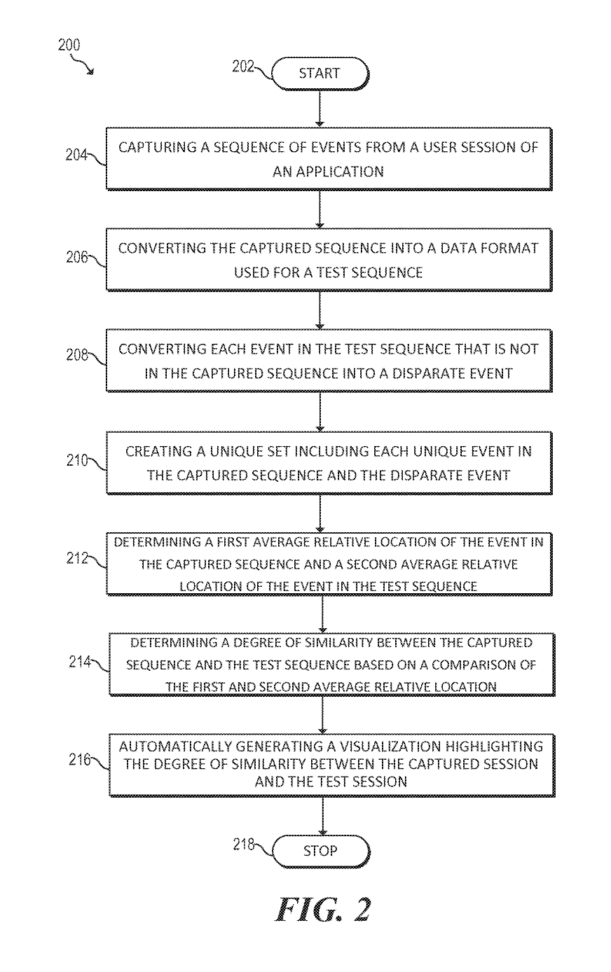

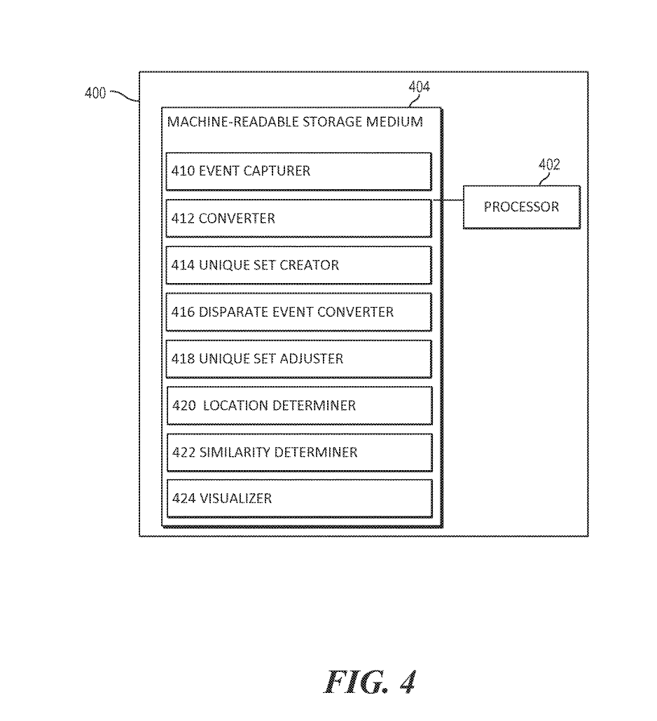

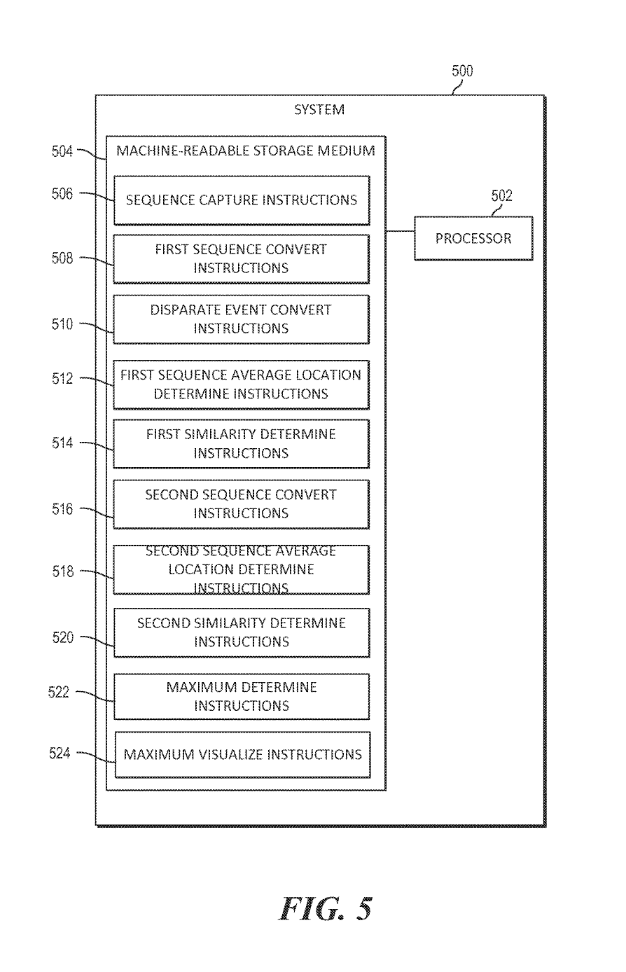

FIG. 2 is a flowchart of an example method 200 for test session similarity determination. Method 200 may be described below as being executed or performed by a system, for example, system 100 of FIG. 1, system 400 of FIG. 4 or system 500 of FIG. 5. Other suitable systems and/or computing devices may be used as well. Method 200 may be implemented in the form of executable instructions stored on at least one machine-readable storage medium of the system and executed by at least one processor of the system. Alternatively or in addition, method 200 may be implemented in the form of electronic circuitry (e.g., hardware). In alternate examples of the present disclosure, at least one step of method 200 may be executed substantially concurrently or in a different order than shown in FIG. 2. In alternate examples of the present disclosure, method 200 may include more or less steps than are shown in FIG. 2. In some examples, at least one of the steps of method 200 may, at certain times, be ongoing and/or may repeat.

Method 200 may start at step 202 and continue to step 204, where the method may include capturing a sequence of events from a user session of an application. A sequence of events is a series of events performed by the application within a given time frame. Example events may include actions performed by a user of an application, pages visited, etc. At step 206, the method may include converting the captured sequence into a data format used for a test sequence. The captured sequence and the test sequence may use a standardized set of event names. In some aspects, the captured sequence and the test sequence may be captured using the same monitoring tool. At step 208, the method may include converting each event in the test sequence that is not in the captured sequence into a disparate event. At step 210, the method may include creating a unique set including each unique event in the captured sequence and the disparate event. At step 212, the method may include determining, for each event in the unique set, a first average relative location of the event in the captured sequence and a second average relative location of the event in the test sequence. At step 214, the method may include determining a degree of similarity between the captured sequence and the test sequence based on a comparison of the first and second average relative location. At step 216 the method may include automatically generating a visualization highlighting the degree of similarity between the captured session and the test session. Method 200 may eventually continue to step 218, where method 200 may stop.

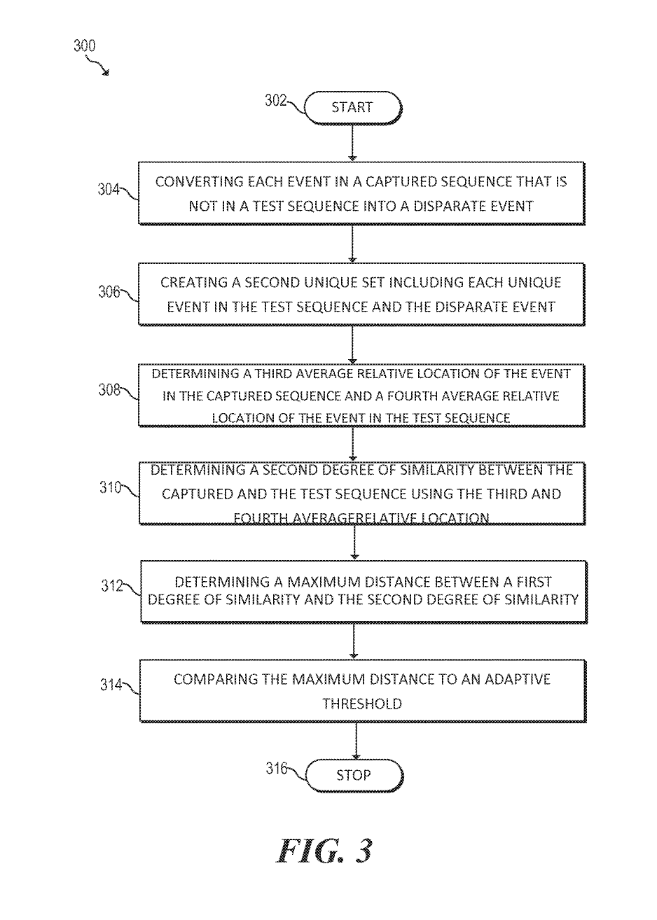

FIG. 3 is a flowchart of an example method 300 for test session similarity determination. Method 300 may be described below as being executed or performed by a system, for example, system 100 of FIG, 1, system 400 of FIG. 4 or system 500 of FIG. 5. Other suitable systems and/or computing devices may be used as well. Method 300 may be implemented in the form of executable instructions stored on at least one machine-readable storage medium of the system and executed by at least one processor of the system. Alternatively or in addition, method 300 may be implemented in the form of electronic circuitry (e.g., hardware). In alternate examples of the present disclosure, at least one step of method 300 may be executed substantially concurrently or in a different order than shown in FIG. 3. In alternate examples of the present disclosure, method 300 may include more or less steps than are shown in FIG. 3. In some examples, at least one of the steps of method 300 may, at certain times, be ongoing and/or may repeat.

Method 300 may start at step 302 and continue to step 304, where the method may include converting each event in a captured sequence that is not in a test sequence into a disparate event. At step 306, the method may include creating a second unique set including each unique event in the test sequence and the disparate event. At step 308, the method may include determining, for each event in the second unique set, a third average relative location of the event in the captured sequence and a fourth average relative location of the event in the test sequence. At step 310, the method may include determining a second degree of similarity between the captured sequence and the test sequence using the first and second average relative location. At step 312, the method may include determining a maximum distance between the first and second degree of similarity. At step 314, the method may include comparing the maximum distance to an adaptive threshold. The adaptive threshold indicates an acceptable degree of similarity to consider the test session and captured session as a match. A sensitivity of the adaptive threshold may be adjusted based on a length of the captured sequence, the test sequence, etc. Method 300 may eventually continue to step 316, where method 300 may stop.

FIG. 4 is a block diagram of an example system 400 for test session similarity determination. FIG. 4 is a block diagram illustrating one example of a processing system 400 for implementing the system 400 for application management based on data correlations. System 400 may include a processor 402 and a memory 404 that may be coupled to each other through a communication link (e.g., a bus). Processor 402 may include a Central Processing Unit (CPU) or another suitable processor. In some examples, memory 404 stores machine readable instructions executed by processor 402 for operating system 400. Memory 404 may include any suitable combination of volatile and/or non-volatile memory, such as combinations of Random Access Memory (RAM), Read-Only Memory (ROM), flash memory, and/or other suitable memory.

Memory 404 stores instructions to be executed by processor 402 including instructions for a event capturer 410, converter 412, unique set creator 414, disparate event converter 416, unique set adjuster 418, location determiner 420, similarity determiner 422 and visualizer 424. The components of system 400 may be implemented in the form of executable instructions stored on at least one machine-readable storage medium of system 400 and executed by at least one processor of system 400. Alternatively or in addition, each of the components of system 400 may be implemented in the form of at least one hardware device including electronic circuitry for implementing the functionality of the component.

Processor 402 may execute instructions of a event capturer 410 to capture a sequence of events from a user session of an application. A sequence of events may be a series of events performed by the application within a given time frame. Example events may include actions performed by a user of an application, pages visited, etc. Processor 402 may execute instructions of a converter 412 to convert the captured sequence into a data format used for a test sequence. The captured sequence and the test sequence may use a standardized set of events names. Processor 402 may execute instructions of a unique set creator 414 to create a unique set including each event in the captured sequence. Processor 402 may execute instructions of a disparate event converter 416 to convert each event in the test sequence that is not in the captured sequence into a disparate event. Processor 402 may execute instructions of a unique set adjuster 418 to add the disparate event to the unique set.

Processor 402 may execute instructions of a location determiner 420 to determine, for each event in the unique set, a first average relative location of the event in the test sequence and a second average relative location of the event in the captured sequence. Processor 402 may execute instructions of a similarity determiner 422 may determine, based on the first average relative location and the second average relative location, whether the test sequence accurately simulates the user session.

Processor 402 may execute instructions of a visualizer 424 may automatically cause the generation of a visualization identifying a difference between the user session and the test session. The visualization may be represented as a graph, a chart, etc. For example, a visualization may display the degree of similarity between the base sequence and the comparison sequence. In this manner, the visualizer 130 may provide the user an easy to understand visualization of the discovered gaps between the base sequence and the comparison sequence. Moreover, the visualization may be presented to a user (such as an application developer, owner, quality assurance agent, etc.) and may be automatically recalibrated based on adjustments made threshold (as described below).

In some examples, processor 402 may execute instructions of a threshold comparer to compare the similarity to a threshold and execute instructions of a threshold adjuster to adjust the threshold. The processor 402 may execute further instructions of the visualizer 422 to automatically recalibrate the visualization based on the adjusted threshold,

FIG. 5 is a block diagram of an example system 500 for test session similarity determination. System 500 may be similar to system 100 of FIG. 1, for example. In the example illustrated in FIG. 5, system 500 includes a processor 502 and a machine-readable storage medium 504. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 502 may be one or more central processing units (CPUs), microprocessors, and/or other hardware devices suitable for retrieval and execution of instructions stored in machine-readable storage medium 504. In the example illustrated in FIG. 5, processor 502 may fetch, decode, and execute instructions 506, 508, 510, 512, 514, 516, 518, 520, 522 and 524 to perform test session similarity determination. As an alternative or in addition to retrieving and executing instructions, processor 502 may include one or more electronic circuits comprising a number of electronic components for performing the functionality of at least one of the instructions in machine-readable storage medium 504. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Machine-readable storage medium 504 may be any electronic, magnetic, optical, or other physical storage device that stores executable instructions. Thus, machine-readable storage medium 504 may be, for example, Random Access Memory (RAM), an Electrically-Erasable Programmable Read-Only Memory (EEPROM), a storage drive, an optical disc, and the like. Machine-readable storage medium 504 may be disposed within system 500, as shown in FIG. 5. In this situation, the executable instructions may be “installed” on the system 500. Alternatively, machine-readable storage medium 504 may be a portable, external or remote storage medium, for example, that allows system 500 to download the instructions from the portable/external/remote storage medium. In this situation, the executable instructions may be part of an “installation package”. As described herein, machine-readable storage medium 504 may be encoded with executable instructions for test session similarity determination.

Referring to FIG. 5, sequence capture instructions 506, when executed by a processor (e.g., 502), may cause system 500 to capture a first sequence of events from a user session of an application. A sequence of events may be a series of events performed by the application within a given time frame. Example events may include actions performed by a user of an application, pages visited, etc. First sequence convert instructions 508, when executed by a processor (e.g., 502), may cause system 500 to convert the first sequence into a data format used for a second sequence of events. The first sequence and the second sequence may use a standardized set of event names. Disparate event convert instructions 510, when executed by a processor (e.g., 502), may cause system 500 to convert each event in the first sequence that is not in the second sequence into a disparate event.

First sequence average relative location determine instructions 512, when executed by a processor (e.g., 502), may cause system 500 to determine, for each event in the second sequence and the disparate event, a first average relative location of the event in the first sequence and a second average relative location of the event in the second sequence. First similarity determine instructions 514, when executed by a processor (e.g., 502), may cause system 500 to determine a first similarity between the first and second sequence using the first and second average relative location. Second sequence convert instructions 516, when executed by a processor (e.g., 502), may cause system 500 to convert each event in the second sequence that is not in the first sequence into the disparate event. Second sequence average relative location determine instructions 518, when executed by a processor (e.g., 502), may cause system 500 to determine, for each event in the first sequence and the disparate event, a third average relative location of the event in the first sequence and a fourth average relative location of the event in the second sequence.

Second similarity determine instructions 520, when executed by a processor (e.g., 502), may cause system 500 to determine a second similarity between the first and second sequence using the third and fourth average relative location. Maximum determine instructions 522, when executed by a processor (e.g., 502), may cause system 500 to determine a maximum between the first similarity and the second similarity. Maximum visualize instructions 524, when executed by a processor (e.g., 502), may cause system 500 to automatically generate a visualization highlighting the maximum.

The foregoing disclosure describes a number of examples for test session similarity determination. The disclosed examples may include systems, devices, computer-readable storage media, and methods for test session similarity determination. For purposes of explanation, certain examples are described with reference to the components illustrated in FIGS. 1-5. The functionality of the illustrated components may overlap, however, and may be present in a fewer or greater number of elements and components. Further, all or part of the functionality of illustrated elements may co-exist or be distributed among several geographically dispersed locations. Further, the disclosed examples may be implemented in various environments and are not limited to the illustrated examples.

Further, the sequence of operations described in connection with FIGS. 1-5 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

1. A method for test session similarity determination, the method comprising:
capturing a sequence of events from a user session of an application;
converting the captured sequence into a data format used for a test sequence;
converting each event in the test sequence that is not in the captured sequence into a disparate event;
creating a unique set including each unique event in the captured sequence and the disparate event;
determining, for each event in the unique set, a first average relative location of the event in the captured sequence and a second average relative location of the event in the test sequence;
determining a degree of similarity between the captured sequence and the test sequence based on a comparison of the first and second average relative location; and
automatically generating a visualization highlighting the degree of similarity between the captured session and the test session.

2. The method of claim 1, further comprising:
determining, for each event in the captured sequence, the order of the event in the captured sequence divided by a length of the captured sequence; and
determining, for each event in the test sequence, the order of the event in the test sequence divided by a length of the test sequence.

3.The method of claim 1 further comprising:
determining, for each event in the unique set, a first distance between the first average relative location and the second average relative location.

4. The method of claim 1 further comprising:
determining, for each event in the unique set, a second distance defining the difference of the first distance from a maximum distance.

5. The method of claim 1 further comprising:
identifying consecutive disparate events in the first sequence; and
combining the consecutive disparate events into a single disparate event.

6. The method of claim 1 further comprising:
converting each event in the captured sequence that is not in the test sequence into the disparate event;
creating a second unique set including each unique event in the test sequence and the disparate event;
determining, for each event in the second unique set, a third average relative location of the event in the captured sequence and a fourth average relative location of the event in the test sequence;
determining a second degree of similarity between the captured and the test sequence using the third and fourth average relative location; and
determining a maximum distance between the first and second degree of similarity.

7. The method of claim 6 further comprising:
comparing the maximum distance to an adaptive threshold, wherein the adaptive threshold indicates an acceptable degree of similarity to consider the test session and captured session as a match.

8. The method of claim 7 further comprising:
adjusting a sensitivity of the adaptive threshold based on a length of at least one of the captured sequence or the test sequence.

9. The method of claim 1 wherein the user session corresponds to a first version of the application and the test session corresponds to a version of the application.

10. A system for test session similarity determination, the system comprising:
an event capturer to capture a sequence of events from a user session of an application;
a converter to convert the captured sequence into a data format used for a test sequence;
a unique set creator to create a unique set including each event in the captured sequence;
a disparate event converter to convert each event in the test sequence that is not in the captured sequence into a disparate event;
a unique set adjuster to add the disparate event to the unique set;
a location determiner to determine, for each event in the unique set, a first average relative location of the event in the test sequence and a second average relative location of the event in the captured sequence;
a similarity determiner to determine, based on the first average relative location and the second average relative location, whether the test sequence accurately simulates the user session; and
a visualizer to automatically generate a visualization highlighting a difference between the user session and the test session.

11. The system of claim 9 further comprising:
a threshold comparer to compare the similarity to an threshold;
a threshold adjuster to adjust the threshold; and
the visualizer to automatically recalibrate the visualization based on the adjusted threshold.

12. The system of claim 9 further comprising:
a session matcher to determine, based on the first average relative location and the second average relative location, whether the test session and the captured session are a match.

13. A non-transitory machine-readable storage medium encoded with instructions for test session similarity determination, the instructions executable by a processor of a system to cause the system to:
capture a first sequence of events from a user session of an application;
convert the first sequence into a data format used for a second sequence of events;
convert each event in the first sequence that is not in the second sequence into a disparate event;
determine, for each event in the second sequence and the disparate event, a first average relative location of the event in the first sequence and a second average relative location of the event in the second sequence;
determine a first similarity between the first and second sequence using the first and second average relative location;
convert each event in the second sequence that is not in the first sequence into the disparate event;
determine, for each event in the first sequence and the disparate event, a third average relative location of the event in the first sequence and a fourth average relative location of the event in the second sequence;
determine a second similarity between the first and second sequence using the third and fourth average relative location;
determine a maximum between the first similarity and the second similarity; and
automatically generate a visualization highlighting the maximum.

14. The non-transitory machine-readable storage medium of claim 13, wherein the instructions executable by the processor of the system further cause the system to:
determine, for each event in the first sequence, the order of the event in the captured sequence divided by a length of first sequence; and
determine, for each event in the second sequence, the order of the event in the second sequence divided by a length of the second sequence.

15. The non-transitory machine-readable storage medium of claim 13, wherein the instructions executable by the processor of the system further cause the system to:
calculate, for each event in the unique set, a distance between first average relative location and the second average relative location.
